(19) United States
(12) Patent Application Publication
(10) Pub. No.: US 2014/0004864 A1
(43) Pub. Date: Jan. 2, 2014

(54) Mechanism To Perform Call Admission Control For Multi-Standard Small Cell

(71) Applicants: Zhibi Wang, Woodridge, IL (US); Ruth S. Gayde, Naperville, IL (US); Joe Huang, Parsippany, NJ (US); John MacNamara, Orland Park, IL (US)

(72) Inventors: Zhibi Wang, Woodridge, IL (US); Ruth S. Gayde, Naperville, IL (US); Joe Huang, Parsippany, NJ (US); John MacNamara, Orland Park, IL (US)

(21) Appl. No.: 13/537,546

(22) Filed: Jun. 29, 2012

(51) Int. Cl. H04W 28/02

(52) U.S. Cl. 455/445

(57) ABSTRACT

A call request is processed by first determining at a shared transport Call Admission Control (CAC) mechanism an occupancy of each of a plurality of technology-specific CAC mechanisms. If one of the plurality of technology-specific CAC mechanisms is not being utilized, transport bandwidth associated with the one of the plurality of technology-specific CAC mechanisms that is not being utilized is assigned to a second of the plurality of technology-specific CAC mechanisms.

### CROSS-REFERENCE TO RELATED APPLICATION

This application claims the benefit of U.S. Provisional Application No. 61/510,321, filed Jul. 21, 2011.

### FIELD OF THE INVENTION

The present invention relates generally to communication systems.

### BACKGROUND OF THE INVENTION

The wireless industry is experiencing ever-increasing growth in data and service traffic. The smart phones and data devices are demanding more and more from wireless networks. To off-load the traffic in densely populated areas and increase indoor coverage, small cells become a feasible solution.

Typically, wireless operators are using multiple technologies in wireless networks due to many reasons, which include mergers and acquisitions, technology advancement, legacy customer retention, new spectrum availability, etc. The small cells used therefore will be a combination of small cells with different technologies, such as UMTS/LTE/WiFi Multi-Standards small cells (MS SC). Typically the MS CS will share the backhaul transport to the core network with Quality of Service (QoS) parameters from each individual technologies.

In the case of many users competing for transport bandwidth, current solutions safeguard the QoS of existing bearers by refusing additional bearers when necessary (which also ensures that the incoming bearers, if admitted, will have the desired quality), employing a so called transport Call Admission Control (T-CAC) for each technology. However, since the MS CS combines all the traffic from different technologies, the existing T-CAC cannot be used for admission control for the combined traffic.

### BRIEF SUMMARY OF THE INVENTION

An exemplary embodiment of the present invention uses a mechanism to perform the transport CAC for the aggregated/combined traffic on the shared transport.

There is currently no T-CAC for MS CS with a combined/aggregated traffic with several technologies to share transport.

### DETAILED DESCRIPTION OF THE INVENTION

In accordance with an exemplary embodiment, for any call/session request that the technology-specific Call Admission Control (CAC) mechanism admits, the shared transport CAC mechanism will accept or reject the call based on the occupancy of each technology-specific CAC. An exemplary embodiment also allows a network operator to define the weighting of particular air interface technologies. This weighting is factored into the transport CAC.

Further, the T-CAC will consider whether any of the multiple technologies is currently not used, in a maintenance condition or out of service when making its decision. In this scenario, if one technology is shut down, other technologies get more transport bandwidth. Further, the T-CAC can consider user profile information when making its decision.

In an exemplary embodiment, a shared transport CAC mechanism can manage a CAC uplink and a CAC downlink in the shared transport.

Several classes of services can preferably be managed with aggregated traffic. In accordance with an exemplary embodiment, sixteen classes of services can be managed. For each class of service it is possible to define a bandwidth for uplink and downlink. For each Class of service it is possible to allocate some QCIs. For each Class of service it is possible to include traffic from multiple technologies.

The congestion conditions on the transport can be provided to each radio CAC, and the technology-specific radio CAC can use this information in deciding to deny a particular request before passing the request to the transport CAC.

An exemplary embodiment enables the T-CAC for a multi-Standard small cell with shared backhaul transport.

While this invention has been described in terms of certain examples thereof, it is not intended that it be limited to the above description, but rather only to the extent set forth in the claims that follow.

We claim:

1. A method for processing a call request comprising:
determining an occupancy of each of a plurality of technology-specific Call Admission Control (CAC) mechanisms;
admitting a call request by one of the plurality of technology-specific CAC mechanisms; and
determining whether to accept the call request by a shared transport CAC mechanism.

2. A method for processing a call request in accordance with claim 1, wherein the step of determining whether to accept the call request comprises determining whether to accept the call request based upon the occupancy of each of the plurality of technology-specific CAC mechanisms.

3. A method for processing a call request in accordance with claim 1, wherein the step of determining whether to accept the call request comprises determining whether to accept the call request utilizing a weighting factor for each of the plurality of technology-specific CAC mechanisms.

4. A method for processing a call request in accordance with claim 1, wherein the step of determining whether to accept the call request comprises determining whether to accept the call request utilizing user profile information.

5. A method for processing a call request in accordance with claim 1, wherein the step of determining whether to accept the call request comprises determining whether to accept the call request at one of the plurality of technology-specific CAC mechanisms.

6. A method for processing a call request comprising:
determining at a shared transport Call Admission Control (CAC) mechanism an occupancy of each of a plurality of technology-specific CAC mechanisms;
determining if one of the plurality of technology-specific CAC mechanisms is not being utilized; and
assigning transport bandwidth associated with the one of the plurality of technology-specific CAC mechanisms that is not being utilized to a second of the plurality of technology-specific CAC mechanisms.

7. A method for processing a call request in accordance with claim 6, wherein the step of determining if one of the plurality of technology-specific CAC mechanisms is not being utilized comprises determining if one of the plurality of technology-specific CAC mechanisms is in a maintenance condition.

8. A method for processing a call request in accordance with claim 6, wherein the step of determining if one of the plurality of technology-specific CAC mechanisms is not being utilized comprises determining if one of the plurality of technology-specific CAC mechanisms is out of service.

9. A method for processing a call request in accordance with claim 6, wherein the step of determining if one of the plurality of technology-specific CAC mechanisms is not being utilized comprises determining if one of the plurality of technology-specific CAC mechanisms is shut down.

10. A method for processing a call request in accordance with claim 6, wherein the step of assigning transport bandwidth comprises assigning transport bandwidth associated with the one of the plurality of technology-specific CAC mechanisms that is not being utilized to a second of the plurality of technology-specific CAC mechanisms and a third the plurality of technology-specific CAC mechanisms.

11. A method for processing a call request in accordance with claim 6, wherein the transport bandwidth comprises uplink transport bandwidth and downlink transport bandwidth.
